(19) United States
(12) Patent Application Publication
(10) Pub. No.: US 2015/0230902 A1
(43) Pub. Date: Aug. 20, 2015

(54) ENDODONTIC FILE FOR ASSESSING ROOT CANAL DEPTH

(71) Applicant: Panayiotis ANDREOU, Delta (CA)

(72) Inventor: Panayiotis ANDREOU, Delta (CA)

(21) Appl. No.: 14/624,919

(22) Filed: Feb. 18, 2015

Related U.S. Application Data
(60) Provisional application No. 61/941,335, filed on Feb. 18, 2014.
(60) Provisional application No. 62/014,557, filed on Jun. 19, 2014.

(51) Int. Cl. A61C 19/04; A61C 5/02

(52) U.S. Cl. CPC A61C 19/041; A61C 19/042; A61C 5/023

(57) ABSTRACT

An endodontic file having an extended measurement range of 14 mm is provided. The endodontic file comprises a shank, a washer and a handle, the shank having a proximal end, a distal end, a proximal region and a fluted region, the washer slidably located about the proximal region of the shank, wherein the improvement comprises an exposed shank in an annular groove in the handle, the exposed shank and the annular groove being about 1 to about 2 mm wide, such that in use, the exposed shank provides a user an extended depth measuring capability. A method of measuring a root canal depth is also provided.

### CROSS REFERENCE TO RELATED APPLICATIONS

This application is related to, and claims the benefit of, U.S. Provisional Patent Application No. 61/941,335, filed Feb. 18, 2014 and U.S. Provisional Patent Application No. 62/014,557, filed Jun. 19, 2014. The above-identified priority patent applications are incorporated herein by reference in their entirety.

### FIELD

The present technology relates to a simple to use and inexpensive endodontic file or probe for measuring canal depth. More specifically, the technology is a file that has a notch or annular groove in the handle to permit use of tool for measuring the two most common depths of canals.

### BACKGROUND

There are numerous approaches to measuring the depth of a root canal including methods that utilize electronic systems.

For example, US Publication No. 20090298004 discloses “an electromagnetically induced cutting mechanism provides accurate cutting operations on soft tissues. The electromagnetically induced cutter is adapted to interact with atomized fluid particles. A tissue remover comprises an aspiration cannula housing a fluid and energy guide for conducting electromagnetically induced cutting forces to the site within a patient's body for aspiration of soft tissue. An endodontic probe is used to perform disinfection procedures on target tissues within root canal passages and tubules. The endodontic probe can include an electromagnetic radiation emitting fiber optic tip having a distal end and a radiation emitting region disposed proximally of the distal end. According to one aspect, the endodontic probe can include a porous structure that encompasses a region of the fiber optic tip excluding the radiation emitting region and that is loaded with biologically-active particles, cleaning particles, biologically-active agents, or cleaning agents for delivery from the porous structure onto the target tissues. Another aspect can include provision of the endodontic probe with an adjustable channel-depth indicator, which encompasses a region of the fiber optic tip besides the radiation emitting region and which is movable in proximal and distal directions along a surface of the fiber optic tip to facilitate the provision of depth-of-insertion information to users of the endodontic probe.”

At Paragraph 19 it is stated: “[0019] Another feature of the present invention includes an endodontic probe for performing disinfection of target tissues within root canal passages and tubules, the endodontic probe comprising (a) an electromagnetic radiation emitting fiber optic tip having a distal end and a radiation emitting region disposed proximally of the distal end and (b) an adjustable channel-depth indicator encompassing a region of the fiber optic tip besides the radiation emitting region. The adjustable channel-depth indicator can be configured to be movable in proximal and distal directions along a surface of the fiber optic tip to provide, for example, depth-of-insertion information to a user of the endodontic probe.” It is not clear exactly how this works, but it is certainly part of a highly complex device and one that would not be amenable to being disposable.

US Publication No. 20070298368 discloses “an instrument for measuring an endodontic length, which measures and indicates the distance from a pointed tip of a cutting tool to a root apex in order to prevent the pointed tip of the cutting tool from going over the root apex when a root canal is perforated by the cutting tool for an endodontic treatment of a root canal of a tooth. The endodontic length measuring instrument is equipped inside a unit chair system installed in a consultation room of a dental clinic and allows a monitor mounted on the unit chair system to display a measurement result of the endodontic length, thereby making a medical treatment of a root canal easy, easily providing a measurement result of the endodontic length to a doctor, and displaying treatment and measurement results of the root canal in various and precise ways. The measuring instrument provides a scaled-up image of the remaining distance from the pointed tip of the cutting tool to the root apex when the pointed tip of the cutting tool reaches an area which demands a more precise measurement result, thereby increasing safety and accuracy in perforation of the root canal.” This is a highly complex way of determining depth of the canal and still requires the use of different probes to determine the depth.

US Publication No. 20070281275 discloses “a device for use in an endodontic root canal, performed using a dental drill hand set has a first upper unit coupled to the drill hand set. The first upper unit is cylindrical in shape and has a first drill shank shaft therethrough. The upper unit has a first threading on its outside surface. A second bottom unit, cylindrical in shape, is also provided, having a second drill shank shaft therethrough. The second bottom unit has a second corresponding threading on its inside surface. When the second bottom unit is screwed onto the first upper unit a root canal jig is formed having a set height and allowing a shank from the drill hand set to pass through the first and second drill shank shafts, such that when the drill shank of the drill hand set is drilled into an affected tooth for a root canal, the drill shank is prevented from drilling along its entire length into the root of the affected tooth when the bottom of the root canal jig contacts the top of the tooth.” It does not describe how the depth of the canal is measured.

US Publication No. 20130337401 discloses “an apex-locating method and device for determining the depth position of the apex in a dental root canal. It uses a device making it possible to form a circuit including a first probe electrode inserted into the root canal of a tooth, a second electrode in conductive contact with an oral mucous membrane, frequency-generating elements able to produce alternating electrical signals at a number of frequencies, and elements for measuring electrical magnitude of alternating signals in the circuit. Provision is made for exciting the circuit and measuring the levels of magnitude of the alternating signals, respectively at low frequency and at high frequency and for detecting a point of intersection where the two levels measured at low and high frequencies meet and become substantially equal, these frequencies being sufficiently far apart for this point of intersection to exist. This point gives the position of the apex.” This again is a complex method of determining the depth and not one amenable to being disposable.

US Publication No. 20090221931 discloses “a method and system for detecting an apical position depending on the change in the impedance between a first electrode inserted into the root canal of the tooth of a patient and a second external electrode applied to a body surface of the patient. According to some embodiments, a regulated current such as an alternating current having a substantially constant amplitude is supplied between the two electrodes, and this current serves as a measurement signal. Alternatively or additionally, the frequency of the time varying (e.g. alternating) current is at least 50 KHZ, and/or at most about 300 KHZ. In some embodiments, the presently disclosed device includes a processing unit which determines a capacitance-governed function when the first electrode is in the apical region, and which determined a function at least moderately governed by resistance when the electrode is in the dental neck region. Optionally, the first electrode inserted into the root canal is a dental file or reamer.” This again is a complex method of determining the depth and not one amenable to being disposable.

US Publication No. 20090148810 discloses “a wireless dental apex locator (10) for use in determining the location of the apex of a patient's root, includes an electronic module (13) having a battery power source (13a), an impedance analyzer circuit (13b) and a radio frequency transmitter (13c); a grounding module (12) having a clip (15) for grounding the patient; a probe module (14) having an endodontic probe (21); and an associated but not physically connected display unit (11) having a receiver (31) for receiving radio frequency signals from the transmitter (13c). The display unit (11) has an electronic circuit that conditions the signals and interprets the signal for display on a graphic display (31).”

US Publication No. 20070218420 discloses “an electrically conductive endodontic instrument coated with a non-conductive layer on a portion of the instrument wherein a proximal and distal portion of the instrument remain uncoated and capable of conducting current therethrough using a traditional apex locator or other alerting means. The non-conductive coatings avoid electrical interference from prior restorative work and anatomical variants. The coatings may be smooth to minimize resistance in the endodontic working space or relatively abrasive to facilitate filing where desired. A method for locating the apex of a tooth utilizing an endodontic instrument coated with an electrically non-conductive layer wherein a proximal and distal portion of the instrument remain uncoated and wherein the instrument is advanced in a root canal space toward the apex of a tooth. When the distal portion of the file makes contact with the apex, and a conductive portion of the file is placed in electrical contact with an apex locator, or other alerting means, said contact actuates an alert thereby establishing canal depth while the coated portion of the instrument avoids electrical artifact from prior restorative work and variant anatomy.”

U.S. Pat. No. 6,872,075 discloses the placement of metallic contact areas on the surface of the plastic handle of the endodontic tool and extending to the shaft of the file. The design is disclosed as a means to improve the accessibility for the clip of the apex locator, by providing an attachment point above the tooth. It is also disclosed as a means to allow the use of insulating sheaths over the metal shafts to prevent short circuits when operating through metal restorations. However, as the contact area is on the surface, it unfortunately, is subject to the same deficiency. In addition, there is a potential for false readings as any contact with the patient's mouth (tongue, side of mouth, lip, etc.) will produce a reading.

Far more simple approaches include using a moveable washer on the file. As disclosed in U.S. Pat. No. 7,300,281 “It is also well known that the desired working length of each file is established by means of a depth stopper 22, usually in the form of a resilient rubber washer, mounted frictionally on the file for adjustment along the length thereof to the desired position as determined from radiographs of the tooth. As indicated hereinbefore, adjustment of the working lengths of files conventionally is accomplished by the use of a ruler and manually adjusting the depth stopper along the length of each file, with the final series of files being shortened progressively by one millimeter increments.”

A more complex measurement system is disclosed in U.S. Pat. No. 4,182,040 where it is disclosed “endodontic files extend freely through openings in a gauge plate supported through a central threaded opening by an elongated, rotatable screw extending upwardly from a base. A post extends upwardly from the base and slidably engages the gauge plate to prevent rotation of the plate while allowing it to move vertically relative to the base upon rotation of the screw, whereby to afford adjustment of the vertical distance between the base and gauge plate to correspond with the depth of radicular pulp to be removed from the root canal of a tooth. Depth stoppers on the files are adjusted along the length of the files to bring them into abutment with the upper surface of the gauge plate, thereby establishing the depth to which the files are to penetrate the root canal. A cover fits removably over the gauge plate and base to retain the files on the gauge plate during transport and to accommodate autoclaving and sterile storage.”

The most commonly used approach to measuring the depth of a root canal involves using a set of files, each being of different lengths (typical file lengths are 21 mm, 25 mm, 31 mm), in conjunction with an apex locator. The clip of the apex locator is placed on the shaft, between the handle of the file and a washer. The practitioner then probes the root canal, moving the washer towards the handle while doing so. The apex locator makes an electrical connection with the metal shaft of the file and indicates when the apex of the root canal has been reached. The practitioner then manually measures the distance from the distal end of the file to the underside of the washer. As the practitioner does not know the depth of the canal, this procedure usually requires the practitioner to use multiple files to probe the canal until the correct length is determined. This is because each file has a limited measurement range, further constrained by the space on the shaft taken up by the clip of the apex locator. What is needed is a simple to use, inexpensive file that allows the practitioner to accurately probe with a single file, rather than two or more files and on that basis, determine the depth.

### SUMMARY

The present technology provides a simple to use, inexpensive endodontic file that allows the practitioner to probe with one file, and on that basis, determine the depth to be anywhere between 17 mm to about 31 mm. The technology removes the need for multiple files that are frequently used in patients. Most patients have root canal depths between 17 and 31 mm, and the current prior art files are 21 mm, 25 mm, or 31 mm—each providing a range of only about 7 mm as compared to the 14 mm offered by the present technology.

In one embodiment an endodontic file having an extended measurement range of 14 mm is provided. The endodontic file comprises a shank, a washer and a handle, the shank having a proximal end, a distal end, a proximal region and a fluted region, the washer slidably located about the proximal region of the shank, wherein the improvement comprises an exposed shank in an annular groove in the handle, the exposed shank and the annular groove being about 1 to about 2 mm wide, such that in use, the exposed shank provides a user an extended depth measuring capability. A method of measuring a root canal depth is also provided.

In the endodontic file, the annular groove may comprise a pair of sidewalls that are substantially normal to the exposed shank.

In the endodontic file, the extended depth measuring capability may be 14 mm.

In the endodontic file, the exposed shank may be about 2 mm wide.

In the endodontic file, the annular groove may be a notch.

In the endodontic file, the annular groove may extend around a circumference of the handle.

In the endodontic file, the shank may be 25 mm long from the proximal end to the distal end.

In the endodontic file the shank may be 21 mm long from the proximal end to the distal end.

In another embodiment, an endodontic file having an extended measurement range of 14 mm is provided, the endodontic file comprising a shank, a washer and a handle, the shank comprising a proximal end, distal end, a proximal region and a fluted region and being 21 or 25 mm long from the proximal end to the distal end, the washer slidably located in the proximal region, and the handle comprising a exposed shank in an annular groove, thereby providing the extended measurement range of 14 mm.

In the endodontic file, the extended measurement range may provide a depth measuring capability of both a 25 mm endodontic file and a 31 mm endodontic file or both a 21 mm endodontic file and a 25 mm endodontic file.

In the endodontic file, the annular groove may be a notch.

In the endodontic file, the annular groove may extend around a circumference of the handle.

In another embodiment, a method of measuring a root canal depth with an endodontic file is provided, wherein the endodontic file comprises a shank, a washer and a handle, the shank having a proximal end, a distal end, a proximal region and a fluted region, the washer slidably located about the proximal region of the shank and the handle comprises an exposed shank in an annular groove, the annular groove being between 1 and 2 mm wide.

In the method, the annular groove may be a notch.

In the method, the annular groove may extend around a circumference of the handle.

In the method, the annular groove may comprise a pair of sidewalls that are substantially normal to the exposed shaft.

In the method, the root canal may have a depth between about 13 mm and 27 mm or 17 mm and 31 mm and the endodontic file may provide a depth measuring range of 14 mm.

### FIGURES

FIG. 1 is a prior art endodontic tool.

FIG. 2 is a medial longitudinal view of the handle of the endodontic tool of the present technology.

FIG. 3 is a side view of another embodiment of the endodontic tool of the present technology.

FIG. 4 is a longitudinal sectional view through a tooth showing the endodontic tool of the technology of FIG. 3.

### DESCRIPTION

Except as otherwise expressly provided, the following rules of interpretation apply to this specification (written description, claims and drawings): (a) all words used herein shall be construed to be of such gender or number (singular or plural) as the circumstances require; (b) the singular terms “a”, “an”, and “the”, as used in the specification and the appended claims include plural references unless the context clearly dictates otherwise; (c) the antecedent term “about” applied to a recited range or value denotes an approximation within the deviation in the range or value known or expected in the art from the measurements method; (d) the words “herein”, “hereby”, “hereof”, “hereto”, “hereinbefore”, and “hereinafter”, and words of similar import, refer to this specification in its entirety and not to any particular paragraph, claim or other subdivision, unless otherwise specified; (e) descriptive headings are for convenience only and shall not control or affect the meaning or construction of any part of the specification; and (f) “or” and “any” are not exclusive and “include” and “including” are not limiting. Further, The terms “comprising,” “having,” “including,” and “containing” are to be construed as open-ended terms (i.e., meaning “including, but not limited to,”) unless otherwise noted.

To the extent necessary to provide descriptive support, the subject matter and/or text of the appended claims is incorporated herein by reference in their entirety.

Recitation of ranges of values herein are merely intended to serve as a shorthand method of referring individually to each separate value falling within the range, unless otherwise indicated herein, and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms used herein have the same meaning as commonly understood by one of ordinary skill in the relevant art. Although any methods and materials similar or equivalent to those described herein can also be used, the acceptable methods and materials are now described.

All methods described herein can be performed in any suitable order unless otherwise indicated herein or otherwise clearly contradicted by context. The use of any and all examples, or exemplary language (e.g., “such as”) provided herein, is intended merely to better illuminate the example embodiments and does not pose a limitation on the scope of the claimed invention unless otherwise claimed. No language in the specification should be construed as indicating any non-claimed element as essential.

### DEFINITIONS

Annular groove—in the context of the present technology, an annular groove can extend fully or partially around the circumference of the handle. The smallest annular groove is a notch.

### DETAILED DESCRIPTION

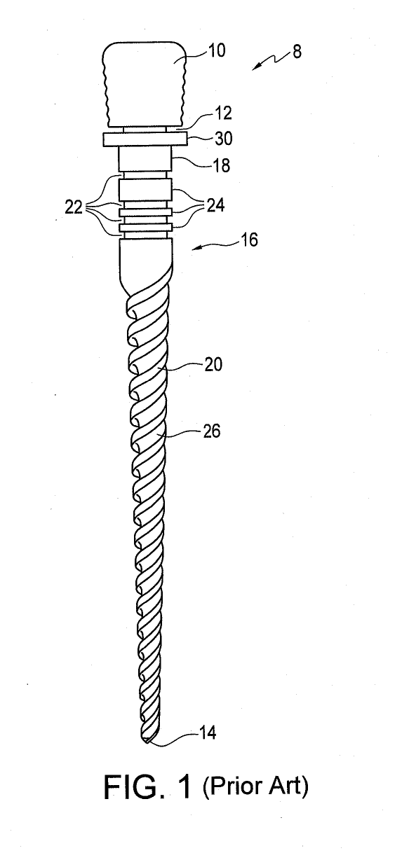

A typical prior art endodontic file, generally referred to as 8, is shown in FIG. 1. The file includes a handle 10 that is at a proximal end 12 of a shank, generally referred to as 16. A distal end 14 of the shank 16 is of a substantially reduced diameter compared to the proximal end 12. The shank 16 is an electrically conductive metal.

The external surface of shank 16 is smooth in a proximal region 18. The proximal region 18 is 7 mm long and extends from the proximal end 12 to a fluted region 20. The proximal region 18 is provided with a series of gaps 22. The gaps 22 are in a series with three spaced 1 mm apart and a fourth spaced 2 mm, with the large spacing 24 being proximal to the narrower spacings 24. The fluted region 20 has a plurality of at least two equally spaced apart continuous helical flutes 26. These helical flutes extend from the proximal region 18 to the distal end 14. There are different shapes and depths of flutes 26 in addition to different widths of the shank 16, depending upon the manufacturer. The shank 14 is an electrically conductive metal.

Slidably received on the shank 16 and illustrated as being adjacent handle 10 is an elastomeric washer 30 that is used by the practitioner to mark the depth of penetration of the shank 16 into the root canal.

In one size of endodontic file 8 the shank 16 is 25 mm long from the handle 10 to the distal end 14 and the washer 30 is 1 mm wide. As the file 8 is worked into the root canal the practitioner can move the washer 30 down against the crown of the tooth to provide an accurate indication of the depth that the file has penetrated into the root canal, as long as it has penetrated between approximately 17 and 24 mm.

In another size, the endodontic file 8 has a shank that is 21 mm long. This allows for accurately measuring the depth of the root canal if the root canal is between 13 and 20 mm deep. Again, as the file 8 is worked into the root canal the practitioner can move the washer 30 down against the crown of the tooth to provide an accurate indication of the depth that the file has penetrated into the root canal.

In yet another size, the endodontic file 8 has a shank that is 31 mm long. This allows for accurately measuring the depth of the root canal if the root canal is between 23 and 30 mm deep. Again, as the file 8 is worked into the root canal the practitioner can move the washer 30 down against the crown of the tooth to provide an accurate indication of the depth that the file has penetrated into the root canal.

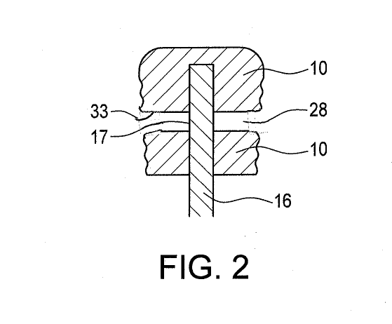

The handle 10 is typically formed of plastic and is of increased diameter and usually includes a surface configured to be easy to grasp and in which slippage is reduced. The shank 16 extends substantially along the length 17 of the handle 10, as shown in FIG. 2.

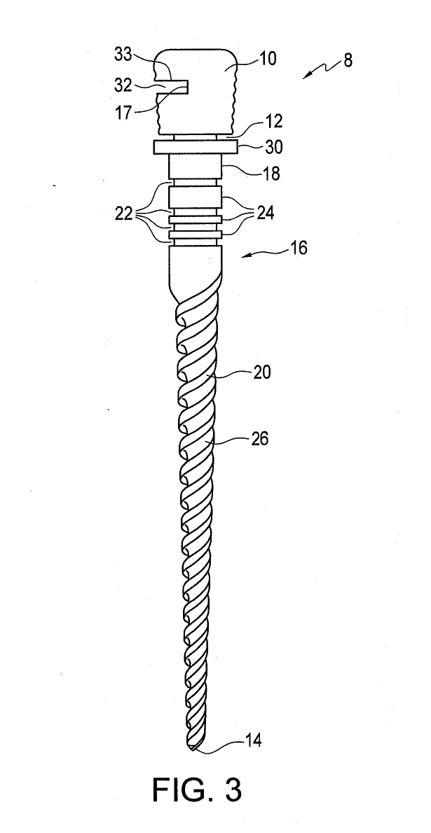

As shown in FIG. 2, the current technology provides an annular groove 28 in the handle 10. The annular groove 28 may extend the full circumference of the handle, or may extend partially around the handle, or may be a notch 32, as shown in FIG. 3, the requirement being that it extends along the circumference enough for the clip of the apex locator to make electrical contact with the exposed shank 17. Therefore, any length of notch from the smallest useable to an annular groove and all sizes in between are contemplated.

The annular groove 28 can be located anywhere along the length 34 of the handle 10, for example, but not limited to 4 mm from the proximal end 12 of the shank 16 (4 mm from the distal end 34 of the handle 10). The annular groove 28 can be between about 1 and about 2 mm wide or any widths therebetween, preferably 2 mm. It must be deep enough to achieve the following: 1. To allow an electrical connection between the exposed shank 17 and the clip of the apex locator; 2. To minimize or prevent contact between the exposed shank 17 and the patient's mouth parts; and 3. To minimize or prevent the clip from slipping. Similarly the width of the annular groove 28 (that extends at least a part of the circumference of the handle) has to be selected to achieve the following: 1. To allow an electrical connection between the exposed shank 17 and the clip of the apex locator; 2. To minimize or prevent contact between the exposed shank 17 and the patient's mouth parts; and 3. To minimize or prevent the clip from slipping. The side walls 33 of the annular groove 28 are preferably substantially normal to the exposed shaft 17, again to reduce the exposure of the exposed shaft 17 to the patient's mouth parts, and to minimize slippage of the clip.

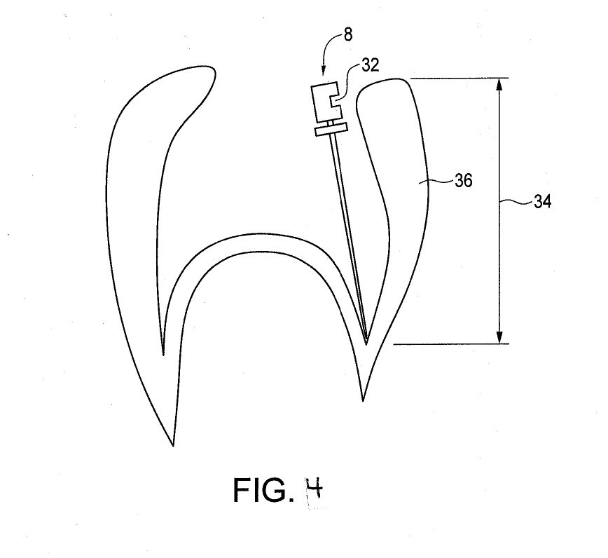

As shown in FIG. 4, the annular groove 28 extends the depth measuring capability 34 of the file 8 in a tooth 36 to 14 mm as compared to the standard capability 36 of 7 or 8 mm. For a 25 mm file, this allows measuring depths between 17 mm and 30 mm or 31 mm. Hence, it can be used on patients having root canals ranging from 17 mm to 31 mm, thereby bridging the two most commonly used sizes of files, those being the 25 mm and the 31 mm files. Alternatively, a 21 mm endodontic file can be provided with the notch. The range of depths that can be measured is 13 mm to 26 mm or 27 mm.

Manufacturing of the handles to provide the present technology is straightforward as the handle can be molded in two pieces, or molded with a notch or partial annular groove or can be molded in one piece followed with cutting the annular groove or notch or partial annular groove in the handle, both methods exposing a section of the shank.

In one exemplary example the notch embodiment is used. The practitioner probes the root canal, moving the washer 30 towards the handle 10 as the shaft 16 probes deeper into the root canal. The clip of the apex locator is placed on the exposed shaft 17 in the notch 32, which is located on any location along the length 34 of the handle 10. This permits an electrical connection between the apex locator and the shaft 16 of the file 8. A measurement is taken, and the clip is removed. The practitioner will repeat probing and measuring until the apex has been reached. Once the apex locator indicates that the apex has been reached, the practitioner removes the file 8 and measures the distance between the distal end 14 of the file 8 and the washer 30. As the clip is not located between the washer 30 and the handle 10, the practitioner is able to measure a greater range of depths with a single file than would be if a file of the prior art was employed.

Advantages of the exemplary embodiments described herein may be realized and attained by means of the instrumentalities and combinations particularly pointed out in this written description. It is to be understood that the foregoing general description and the following detailed description are exemplary and explanatory only and are not restrictive of the claims below. While example embodiments have been described in detail, the foregoing description is in all aspects illustrative and not restrictive. It is understood that numerous other modifications and variations can be devised without departing from the scope of the example embodiment.

While example embodiments have been described in connection with what is presently considered to be an example of a possible most practical and/or suitable embodiment, it is to be understood that the descriptions are not to be limited to the disclosed embodiments, but on the contrary, is intended to cover various modifications and equivalent arrangements included within the spirit and scope of the example embodiment. Those skilled in the art will recognize, or be able to ascertain using no more than routine experimentation, many equivalents to the specific example embodiments specifically described herein. Such equivalents are intended to be encompassed in the scope of the claims, if appended hereto or subsequently filed.

1. An endodontic file for use with an apex locator for assessing a root canal depth, the endodontic file comprising a shank, a washer and a handle, the shank having a proximal end, a distal end, a proximal region and a fluted region, the washer slidably located about the proximal region of the shank, wherein the improvement comprises an exposed shank in an annular groove in the handle, the exposed shank and the annular groove being about 1 to about 2 mm wide, such that in use, the exposed shank provides a user an extended depth measuring capability.

2. The endodontic file of claim 1, wherein the annular groove comprises a pair of sidewalls that are substantially normal to the exposed shank.

3. The endodontic file of claim 2, wherein the extended depth measuring capability is 14 mm.

4. The endodontic file of claim 3, wherein the exposed shank is about 2 mm wide.

5. The endodontic file of claim 4, wherein the annular groove is a notch.

6. The endodontic file of claim 4, wherein the annular groove extends around a circumference of the handle.

7. The endodontic file of claim 6, wherein the shank is 25 mm long from the proximal end to the distal end.

8. The endodontic file of claim 6, wherein the shank is 21 mm long from the proximal end to the distal end.

9. An endodontic file having an extended measurement range of 14 mm, the endodontic file comprising a shank, a washer and a handle, the shank comprising a proximal end, distal end, a proximal region and a fluted region and being 21 or 25 mm long from the proximal end to the distal end, the washer slidably located in the proximal region, and the handle comprising a exposed shank in an annular groove, thereby providing the extended measurement range of 14 mm.

10. The endodontic file of claim 9, wherein the extended measurement range provides a depth measuring capability of both a 25 mm endodontic file and a 31 mm endodontic file or both a 21 mm endodontic file and a 25 mm endodontic file.

11. The endodontic file of claim 10 wherein the annular groove is a notch.

12. The endodontic file of claim 10, wherein the annular groove extends around a circumference of the handle.

13. A method of measuring a root canal depth with an endodontic file, wherein the endodontic file comprises a shank, a washer and a handle, the shank having a proximal end, a distal end, a proximal region and a fluted region, the washer slidably located about the proximal region of the shank and the handle comprises an exposed shank in an annular groove, the annular groove being between 1 and 2 mm wide.

14. The method of claim 13 wherein the annular groove is a notch.

15. The method of claim 14, wherein the annular groove extends around a circumference of the handle.

16. The method of claim 15, wherein the annular groove comprises a pair of sidewalls and the sidewalls are substantially normal to the exposed shaft.

17. The method of claim 16, wherein the root canal has a depth between about 13 mm and 27 mm or 17 mm and 31 mm and the endodontic file providing a depth measuring range of 14 mm.
